(19) United States
(12) Patent Application Publication
(10) Pub. No.: US 2026/0302116 A1
(43) Pub. Date: Oct. 1, 2026

(54) RELAY

(71) Applicant: SENSATA TECHNOLOGIES (WUHU) CO., LTD., Wuhu (CN)

(72) Inventors: Hong XU, Wuhu (CN); Haiyu ZHOU, Wuhu (CN); Chaoqun YANG, Wuhu (CN); Jiale MENG, Wuhu (CN); Yulong ZHANG, Wuhu (CN); Hao FENG, Wuhu (CN); Yahui MA, Wuhu (CN); Shun WANG, Wuhu (CN)

(21) Appl. No.: 19/631,410

(22) Filed: Mar. 27, 2026

(30) Foreign Application Priority Data
Mar. 28, 2025 (CN) 202510402515.2

(51) Int. Cl. H01H 50/60; H01H 50/16; H01H 50/34; H01H 50/64; H01H 51/06

(52) U.S. Cl. CPC H01H 50/60; H01H 50/163; H01H 50/34; H01H 50/645; H01H 51/06

(57) ABSTRACT

The present application discloses a relay comprising: a stationary contact element extending into a contact chamber defined by a housing of the relay; a movable contact element configured to move toward the stationary contact element during operation such that the movable contact element comes into contact with the stationary contact element to achieve conduction of an electric circuit; a first magnetic conductive member disposed within the contact chamber; and a second magnetic conductive member coupled to the movable contact element and configured to form a magnetic circuit with the first magnetic conductive member when the movable contact element contacts the stationary contact element. The second magnetic conductive member is configured to be movable toward the first magnetic conductive member when the movable contact element contacts the stationary contact element, so as to change a distance between the first magnetic conductive member and the second magnetic conductive member.

### TECHNICAL FIELD

The present application generally relates to a relay, which has a floating magnetic conductive structure.

### BACKGROUND ART

In the field of electrical control, relays are widely used as a crucial control element. Conventional relays mainly consist of stationary contacts, movable contacts, electromagnetic systems and upper and lower magnetic conductive blocks for magnetic circuit conduction. The working principle is that when the electromagnetic system is energized, a magnetic field is generated to attract the movable contact to move toward the stationary contact until both are in contact, thereby achieving the conduction of the circuit. At this time, the upper and lower magnetic conductive blocks play a key role. They ensure that the movable contact and the stationary contact remain in tight contact through the force produced by mutual attraction when the stationary contact and the movable contact are in contact, effectively preventing the two from separating, thereby ensuring stable conduction of the circuit.

However, in existing relay designs, the upper and lower magnetic conductive blocks are usually installed in a fixed manner. This fixed structure has certain defects, namely, it cannot flexibly adjust the amount of the attraction between the upper and lower magnetic conductive blocks according to actual work requirements.

### SUMMARY OF DISCLOSURE

One object of the present application is to provide a relay capable of overcoming at least one defect in the prior art.

An object of the present application is to provide a relay, wherein its lower magnetic conductive block is floating and can change the distance from an upper magnetic conductive block during operation.

Another object of the present application is to provide a relay, which can obtain a compact design and can also achieve multiple functions such as guiding and constraining.

According to a first aspect of the present application, there is provided a relay comprising:
a stationary contact element extending into a contact chamber defined by a housing of the relay;
a movable contact element configured to move toward the stationary contact element during operation such that the movable contact element comes into contact with the stationary contact element to achieve conduction of an electric circuit;
a first magnetic conductive member disposed within the contact chamber; and
a second magnetic conductive member coupled to the movable contact element and configured to form a magnetic circuit with the first magnetic conductive member when the movable contact element contacts the stationary contact element;
wherein the second magnetic conductive member is configured to be movable toward the first magnetic conductive member when the movable contact element contacts the stationary contact element, so as to change a distance between the first magnetic conductive member and the second magnetic conductive member.

By enabling the second magnetic conductive member to move toward the first magnetic conductive member when the movable contact element contacts the stationary contact element, the distance between the first magnetic conductive member and the second magnetic conductive member can be changed, thereby adjusting the attraction between the first magnetic conductive member and the second magnetic conductive member.

In some embodiments of the relay, an elastic element is provided between the movable contact element and the second magnetic conductive member, such that the second magnetic conductive member moves toward the first magnetic conductive member against an elastic force of the elastic element when the movable contact element contacts the stationary contact element.

By providing an elastic element between the movable contact element and the second magnetic conductive member, not only can it help adjust a distance and an attraction between the first magnetic conductive member and the second magnetic conductive member, but also it can help bias the movable contact element into maintaining contact with the stationary contact element.

In some embodiments of the relay, the second magnetic conductive member is coupled to the movable contact element via the elastic element.

In some embodiments of the relay, the movable contact element is located between the first magnetic conductive member and the second magnetic conductive member.

In a case where the movable contact element is located between the first magnetic conductive member and the second magnetic conductive member, an overall layout structure of the magnetic conductive members and the contact elements is more compact, and a distance between the first magnetic conductive member and the second magnetic conductive member can be better controlled and adjusted, avoiding occurrence of unexpected situations.

In some embodiments of the relay, the second magnetic conductive member is configured to move between a first position and a second position relative to the movable contact element, wherein a distance between the first magnetic conductive member and the second magnetic conductive member when in the first position is greater than a distance between the first magnetic conductive member and the second magnetic conductive member when in the second position, and wherein the elastic element is configured to bias the second magnetic conductive member toward the first position.

Biasing of the elastic element can be conducive to adjustment of a distance between the first magnetic conductive member and the second magnetic conductive member, and conducive to resetting of the second magnetic conductive member.

In some embodiments of the relay, the elastic element is a helical spring or a butterfly spring.

In some embodiments of the relay, the second magnetic conductive member is provided with a first receiving portion, the movable contact element is provided with a corresponding second receiving portion, and two ends of the elastic element are received at the first receiving portion and the second receiving portion, respectively.

In some embodiments of the relay, the second magnetic conductive member is provided with a first receiving portion, and the elastic element includes a spring body and a deformable portion extending from the spring body, and wherein the spring body is fixed to the movable contact element, and an end of the deformable portion is received at the first receiving portion.

The spring body being fixed to the movable contact element and the first receiving portion guiding and constraining movement of the deformable portion can be conducive to adjustment of a distance between the second magnetic conductive member and the movable contact element, and conducive to normal operation of the elastic element.

In some embodiments of the relay, the second magnetic conductive member is formed as a U-shaped structure, the movable contact element is arranged between two sides of the U-shaped structure, such that when the second magnetic conductive member moves toward the first magnetic conductive member, the second magnetic conductive member is guided along an edge of the movable contact element to move relative to the movable contact element.

By forming the second magnetic conductive member into a U-shaped structure and arranging the movable contact element between two sides of the U-shaped structure, movement of the second magnetic conductive member along a height direction can be guided and shifting of the second magnetic conductive member along a width direction can be prevented.

In some embodiments of the relay, the relay further includes a mounting bracket fixed to the movable contact element to movably constrain the second magnetic conductive member between the mounting bracket and the movable contact element.

On one hand, the mounting bracket can movably connect the second magnetic conductive member to the movable contact element, and on the other hand, it can constrain movement of the second magnetic conductive member, which is conducive to defining a range of movement of the second magnetic conductive member.

In some embodiments of the relay, the mounting bracket has a bracket body fixed to the movable contact element.

In some embodiments of the relay, each of two ends of the bracket body is formed with a supporting section configured for supporting the second magnetic conductive member.

In some embodiments of the relay, the second magnetic conductive member includes two protruding sections each formed in the form of a U-shaped structure, the movable contact element is arranged between the two protruding sections, and each of the supporting sections is arranged between two legs of a respective protruding section and configured for supporting a connecting portion of the respective protruding section.

In some embodiments of the relay, the second magnetic conductive member includes two abutment sections each connected to one corresponding leg of each of the two protruding sections, such that the two abutment sections and the two protruding sections together form a U-shaped structure.

Such arrangement of the second magnetic conductive member and the mounting bracket not only can obtain a compact arrangement, and support and constrain the second magnetic conductive member, but also can guide movement of the second magnetic conductive member in the height direction and prevent shifting of the second magnetic conductive member in the length direction.

In some embodiments of the relay, the mounting bracket has a bracket section extending from the bracket body, and the second magnetic conductive member includes an abutment section, and wherein the bracket section is configured for supporting the abutment section and/or guiding movement of the abutment section.

In some embodiments of the relay, the second magnetic conductive member includes two abutment sections, and the mounting bracket correspondingly has two bracket sections extending from opposite sides of the bracket body.

In some embodiments of the relay, the bracket section includes a guiding portion extending from the bracket body and a supporting portion extending from an end of the guiding portion opposite to the bracket body, the guiding portion cooperates with the abutment section to guide movement of the abutment section, and the supporting portion is configured for supporting the abutment section, thereby supporting the abutment section in the height direction and preventing the second magnetic conductive member from falling out between the movable contact element and the mounting bracket.

In some embodiments of the relay, the abutment section is provided with a protrusion, and the supporting portion is formed with a guiding recess cooperating with the protrusion to guide movement of the protrusion.

The relay according to the present application regulates a distance between the magnetic conductive members by adopting a floating magnetic conductive structure, so as to regulate attraction between the magnetic conductive members. Further, by providing the magnetic conductive member associated with the movable contact element into a floating magnetic conductive member, not only can the distance be regulated, but also elastic force of the elastic element can be fully utilized to additionally promote contact between the stationary contact element and the movable contact element. In addition, assembly of the movable contact element, the mounting bracket and the magnetic conductive member forms a compact structure, which fully utilizes shape cooperation between the respective members, not only saves space, but also obtains additional guiding and constraining effects.

### BRIEF DESCRIPTION OF FIGURES

Multiple aspects of the present application will be better understood after reading the following description of the embodiments in conjunction with the drawings, in which:

FIG. 1 is a perspective sectional view of a relay according to some embodiments of the present application;

FIG. 2 is a sectional view of the relay according to some embodiments of the present application;

FIG. 3 is an exploded perspective view of a floating structure of the relay according to some embodiments of the present application;

FIG. 4 is a perspective sectional view of the floating structure of the relay according to some embodiments of the present application;

FIG. 5 is a sectional view of the floating structure of the relay according to some embodiments of the present application;

FIG. 6 is an exploded perspective view of a floating structure of a relay according to other embodiments of the present application;

FIG. 7 is a perspective sectional view of the floating structure of the relay according to other embodiments of the present application; and

FIG. 8 is a sectional view of the floating structure of the relay according to other embodiments of the present application.

### LIST OF REFERENCE SIGNS

relay 1;

stationary contact element 10; housing 11; contact chamber 12;
movable contact element 20; second receiving portion 22; mounting hole 202;
first magnetic conductive member 30;
second magnetic conductive member 40; first receiving portion 42; abutment section 44;
protruding section 46; protrusion 48; leg 462; connecting portion 464;
pushing assembly 50; base 52; pushing rod 54; spring 56;
elastic element 60; spring body 62; deformable portion 64; mounting hole 622;
mounting bracket 70; bracket body 72; bracket section 74; supporting section 722;
mounting hole 724; guiding portion 742; supporting portion 744; guiding recess 746.

### DETAILED DESCRIPTION OF EMBODIMENTS

The present application will be described below with reference to the drawings, in which several embodiments of the present application are shown. However, it should be understood that the present application may be embodied in many different ways and is not limited to the embodiments described below; in fact, the embodiments described below are intended to make the disclosure of the present application more complete and to fully explain the scope of protection of the present application to those skilled in the art. It should also be understood that the embodiments disclosed herein can be combined in various ways to provide more additional embodiments.

It should be understood that in all the drawings, like reference signs denote like elements. In the drawings, for clarity, certain features may be exaggerated.

It should be understood that the terminology used in the specification is for describing specific embodiments only and is not intended to limit the present application. All terms (including technical and scientific terms) used in the specification have their usual meanings as commonly understood by those skilled in the art unless otherwise defined. For the sake of brevity and/or clarity, known functions or structures will not be described in detail.

The singular forms “a”, “an” and “the” used in the specification include plural forms unless clearly indicated otherwise. The terms “comprise”, “include” and “contain” used in the specification indicate the presence of stated features but do not exclude the presence of one or more other features. The term “and/or” used in the specification includes any and all combinations of one or more of the associated listed items. The terms “between X and Y” and “between about X and Y” used in the specification shall be interpreted as including X and Y. The term “between about X and Y” used in this specification means “between about X and about Y”, and the term “from about X to Y” used in this specification means “from about X to about Y”.

In the specification, when it is said that an element is located “on”, “attached” to, “connected” to, “coupled” to, or “in contact with” another element, the element can be directly located on, attached to, connected to, coupled to, or in contact with the other element, or there can be an intermediate element. By contrast, when it is said that an element is “directly” located “on”, “directly attached” to, “directly connected” to, “directly coupled” to, or “directly in contact with” another element, there will be no intermediate element. In the specification, a feature arranged to be “adjacent” to another feature can refer to the feature having a part overlapping with the adjacent feature or a part located above or below the adjacent feature.

Spatial relationship terms such as “above”, “below”, “left”, “right”, “front”, “rear”, “high” and “low” used in the specification can describe the relationship between one feature and another feature in the drawings. It should be understood that spatial relationship terms include not only the orientations shown in the drawings, but also different orientations of the device during use or operation. For example, when the device in the drawings is inverted, the feature previously described as being “below” other feature can now be described as being “above” the other feature. The device can also be oriented in other ways (rotated 90 degrees or in other orientations), and the relative spatial relationships will be correspondingly interpreted.

In the field of electrical control, relays are widely used as a crucial control element. Conventional relays mainly consist of stationary contacts, movable contacts, electromagnetic systems and upper and lower magnetic conductive blocks for magnetic circuit conduction. The working principle is that when the electromagnetic system is energized, a magnetic field is generated to attract the movable contact to move toward the stationary contact until both are in contact, thereby achieving the conduction of the circuit. At this time, the upper and lower magnetic conductive blocks play a key role. They ensure that the movable contact and the stationary contact remain in tight contact through the force produced by mutual attraction when the stationary contact and the movable contact are in contact, effectively preventing the two from separating, thereby ensuring stable conduction of the circuit.

However, in existing relay designs, the upper and lower magnetic conductive blocks are usually installed in a fixed manner. This fixed structure has some defects, namely, it cannot flexibly adjust the amount of the attraction between the upper and lower magnetic conductive blocks according to actual work requirements. Under different electrical working scenarios, for example, under different voltage and current conditions, or when different requirements are placed on the stability of circuit conduction, a fixed magnitude of attraction may not meet the optimal working state.

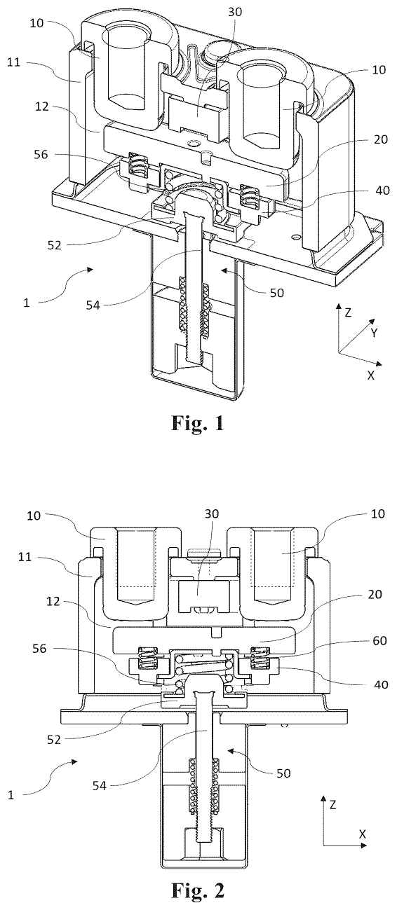

Referring to FIGS. 1 and 2, FIG. 1 shows a sectional perspective view of a relay 1 according to some embodiments of the present application, and FIG. 2 shows a sectional view of the relay 1 according to some embodiments of the present application. For the sake of clear description, mutually orthogonal X direction (which may also be referred to as length direction), Y direction (which may also be referred to as width direction) and Z direction (which may also be referred to as height direction) may be defined, as shown in FIG. 1, wherein the movable contact moves along the Z direction to contact the stationary contact.

The relay 1 may include a stationary contact element 10 extending into a contact chamber 12 formed by a housing 11 and a movable contact element 20 disposed in the contact chamber 12. The housing 11 may be made of materials such as plastic, ceramic, metal, etc., for example, polybutylene terephthalate (PBT), polycarbonate (PC), polyamide (PA), polyoxymethylene (POM), etc.

During the operation of the relay 1, the movable contact element 20 moves in the height direction toward the stationary contact element 10 to contact the stationary contact element 10 within the contact chamber 12 so as to achieve the conduction of the circuit. In the illustrated embodiment, the relay 1 is shown to have two stationary contact elements 10 and one movable contact element 20, and the lead-out end of the stationary contact element 10 is used to contact the movable contact element 20. Those skilled in the art can understand that other suitable forms and numbers of stationary contact elements 10 and movable contact elements 20 may also be adopted as needed. The stationary contact element 10 and the movable contact element 20 may be made of conductive materials, for example, silver-based alloys, copper-based alloys, precious metal materials, or any other suitable materials known in the art, for example, silver-nickel, silver-cadmium oxide, silver-tin oxide, silver-tungsten, silver-coated copper, copper-chromium, gold, platinum, palladium, tungsten carbide, etc.

Generally, the relay 1 may further include a pushing assembly 50 configured to push the movable contact element 20 toward the stationary contact element 10 in the height direction so as to contact the stationary contact element 10. The pushing assembly 50 may include a base 52 and a pushing rod 54 coupled to the base 52. A spring 56 may be provided on a side of the base 52 opposite to the pushing rod 54, and coupled to the movable contact element 20. When a coil is energized, the pushing rod 54 is driven to move in the height direction, and then pushes the movable contact element 20 to move in the height direction via the spring 56. When the movable contact element 20 comes into contact with the stationary contact element 10, it stops moving in the height direction. At this time, the driving force of the pushing rod 54 can be buffered by the spring 56, and the contact between the movable contact element 20 and the stationary contact element 10 can be maintained.

When the movable contact element 20 contacts the stationary contact element 10, the circuit is conductive and current flows through the movable contact element 20 and the stationary contact element 10. At this time, repulsion may be generated between the movable contact element 20 and the stationary contact element 10, tending to separate and disengage the movable contact element 20 from the stationary contact element 10. This repulsion may exceed the thrust of the driving member 50 applied on the movable contact element 20, and ultimately cause the movable contact element 20 to separate from the stationary contact element 10. In this case, in order to ensure the contact between the movable contact element 20 and the stationary contact element 10, a magnetic conductive member can be provided to prevent the movable contact element 20 from separating from the stationary contact element 10. Specifically, the relay 1 can be provided with a first magnetic conductive member 30 and a second magnetic conductive member 40. The first magnetic conductive member 30 can be coupled to, for example, the housing 11 or the stationary contact element 10, and the second magnetic conductive member 40 can be coupled to the movable contact element 20. When the movable contact element 20 contacts the stationary contact element 10, a magnetic conductive circuit is formed between the first magnetic conductive member 30 and the second magnetic conductive member 40, thereby generating attraction between the first magnetic conductive member 30 and the second magnetic conductive member 40, and thus enhancing and maintaining the contact between the movable contact element 20 and the stationary contact element 10.

The relay according to the present application can be used as an electrical control device and widely applied in multiple fields such as power, industry, communication, home appliances, etc. For example, the relay can be used in power systems such as substations, transmission lines, etc., industrial automation such as motor control, production lines, etc., communication field such as switching equipment, communication power supply, etc., home appliance field such as air conditioners, refrigerators, etc., automotive electronics such as starting circuits, lighting control, etc., smart home such as smart switches, security systems, etc.

The following will refer to FIGS. 1-8 to describe in detail the relay 1 according to some embodiments of the present application, which includes floating magnetic conductive members, that is, the second magnetic conductive member 40 can move relative to the first magnetic conductive member 30.

According to some embodiments of the present application, a relay 1 is provided, which may include: a stationary contact element 10 extending into a contact chamber 12 defined by a housing 11 of the relay 1; a movable contact element 20 configured to move toward the stationary contact element 10 during operation such that the movable contact element 20 can come into contact with the stationary contact element 10 to achieve conduction of an electric circuit; a first magnetic conductive member 30 disposed within the contact chamber 12; and a second magnetic conductive member 40 coupled to the movable contact element 20 and configured to form a magnetic circuit with the first magnetic conductive member 30 when the movable contact element 20 contacts the stationary contact element 10. The second magnetic conductive member 40 can be configured to be movable toward the first magnetic conductive member 30 when the movable contact element 20 contacts the stationary contact element 10, so as to change a distance between the first magnetic conductive member 30 and the second magnetic conductive member 40.

As described above, referring to FIGS. 1 and 2, the relay 1 can include a stationary contact element 10 and a movable contact element 20. During the operation of the relay 1, the stationary contact element 10 and the movable contact element 20 contact each other in the contact chamber 12 to achieve conduction of the circuit. After the stationary contact element 10 and the movable contact element 20 contact each other, in order to ensure the conduction of the circuit, it is necessary to maintain the contact between the stationary contact element 10 and the movable contact element 20. However, when the stationary contact element 10 and the movable contact element 20 contact each other, mutual repulsion may be generated therebetween. Once the repulsion exceeds the thrust of the driving member applied on the movable contact element 20, the stationary contact element 10 and the movable contact element 20 may disengage from each other. For this reason, magnetic conductive members can be provided in the relay 1. Attraction can be generated by forming a magnetic conductive circuit between the magnetic conductive members. Specifically, the relay 1 can be provided with a first magnetic conductive member 30 and a second magnetic conductive member 40. The first magnetic conductive member 30 can be disposed in the contact chamber 12, for example, can be coupled to the housing 11 or the stationary contact element 10, and the second magnetic conductive member 40 can be coupled to the movable contact element 20, so that when the movable contact element 20 is pushed to move toward the stationary contact element 10, the second magnetic conductive member 40 moves toward the stationary contact element 10 following the movable contact element 20. When the movable contact element 20 contacts the stationary contact element 10, a magnetic conductive circuit is formed between the first magnetic conductive member 30 and the second magnetic conductive member 40, thereby generating attraction between the first magnetic conductive member 30 and the second magnetic conductive member 40, and thus enhancing and maintaining the contact between the movable contact element 20 and the stationary contact element 10. The magnetic conductive member can be made of magnetic conductive materials such as metal materials, ferrite materials, and other composite materials, for example, iron, low carbon steel, iron-silicon alloy, iron-aluminum alloy, nickel-iron alloy, cobalt alloy, soft magnetic ferrite, soft magnetic composite material, processable magnetic body, etc.

According to embodiments of the present application, the second magnetic conductive member 40 can be configured to be movable toward the first magnetic conductive member 30 when the movable contact element 20 contacts the stationary contact element 10, so as to change the distance between the first magnetic conductive member 30 and the second magnetic conductive member 40.

As described above, when the movable contact element 20 contacts the stationary contact element 10, a magnetic conductive circuit is formed between the first magnetic conductive member 30 and the second magnetic conductive member 40, thereby generating attraction between the first magnetic conductive member 30 and the second magnetic conductive member 40. In the case that the material, shape and size of the magnetic conductive members do not change, the magnitude of the attraction is related to the magnetic field strength and the distance between the two magnetic conductive members. By changing the magnitude of the current, for example, the magnetic field strength can be changed to adjust the magnitude of the attraction between the first magnetic conductive member 30 and the second magnetic conductive member 40. However, adjusting the attraction by changing the magnitude of the current, for example, may lead to the relay becoming complicated, increasing the difficulty of control, and at the same time may increase the failure rate, increase energy consumption, and increase costs. For this reason, the present application considers regulating the attraction between the first magnetic conductive member 30 and the second magnetic conductive member 40 by changing the distance between the first magnetic conductive member 30 and the second magnetic conductive member 40.

When the movable contact element 20 contacts the stationary contact element 10, the movable contact element 20 and the stationary contact element 10 remain relatively immobile due to this contact. At this time, if both the first magnetic conductive member 30 and the second magnetic conductive member 40 are fixed-type magnetic conductive members, they will also remain immobile, the distance between the first magnetic conductive member 30 and the second magnetic conductive member 40 remains unchanged, and thus the attraction remains unchanged. According to embodiments of the present application, when the movable contact element 20 contacts the stationary contact element 10, a magnetic conductive circuit is formed between the first magnetic conductive member 30 and the second magnetic conductive member 40, thereby generating an attraction between the first magnetic conductive member 30 and the second magnetic conductive member 40. By means of this attraction, the second magnetic conductive member 40 can be forced to move further toward the first magnetic conductive member 30, so as to change the distance between the first magnetic conductive member 30 and the second magnetic conductive member 40, thereby changing the attraction between the first magnetic conductive member 30 and the second magnetic conductive member 40. In the case where the second magnetic conductive member 40 further moves toward the first magnetic conductive member 30, the distance between the first magnetic conductive member 30 and the second magnetic conductive member 40 decreases, and the attraction between the first magnetic conductive member 30 and the second magnetic conductive member 40 increases, thereby the speed of the second magnetic conductive member 40 moving toward the first magnetic conductive member 30 can also be increased.

By enabling the second magnetic conductive member 40 to move toward the first magnetic conductive member 30 when the movable contact element 20 contacts the stationary contact element 10, the distance between the first magnetic conductive member 30 and the second magnetic conductive member 40 can be changed, and thus the attraction between the first magnetic conductive member 30 and the second magnetic conductive member 40 can be regulated.

According to some embodiments of the present application, an elastic element 60 can be provided between the movable contact element 20 and the second magnetic conductive member 40, such that when the movable contact element 20 contacts the stationary contact element 10, the second magnetic conductive member 40 moves toward the first magnetic conductive member 30 against an elastic force of the elastic element 60.

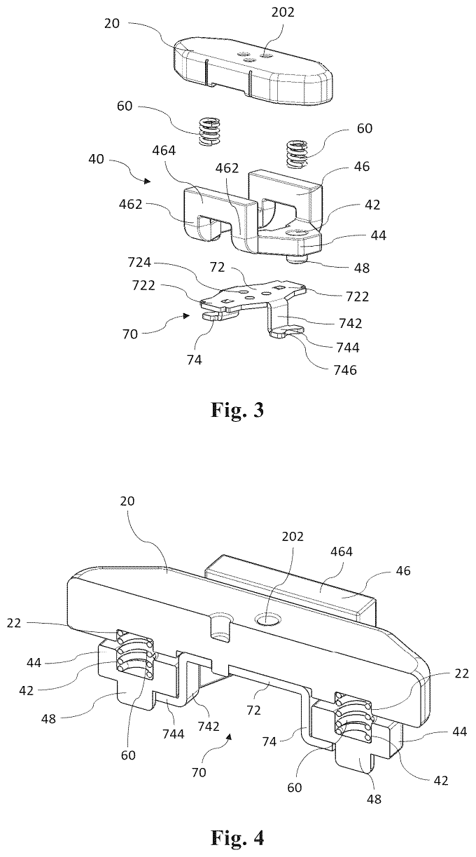

As shown in FIGS. 3 to 8, FIGS. 3 to 5 show schematic diagrams of a floating structure of relay 1 of some embodiments, and FIGS. 6 to 8 show schematic diagrams of a floating structure of relay 1 of other embodiments. As shown in FIGS. 3 to 5, the elastic element 60 is in the form of a helical spring. Two helical springs are shown in the illustrated embodiment, but those skilled in the art should understand that any suitable number of helical springs may be adopted according to actual application needs. The elastic element 60 is disposed between the movable contact element 20 and the second magnetic conductive member 40. In the case where the second magnetic conductive member 40 continues to move toward the first magnetic conductive member 30 when the movable contact element 20 contacts the stationary contact element 10, since the movable contact element 20 remains immobile at this time, the second magnetic conductive member 40 also moves relative to the movable contact element 20, specifically moving toward (the situation in the illustrated embodiment) or away from (not shown) the movable contact element 20. The elastic element 60 between the movable contact element 20 and the second magnetic conductive member 40 is compressed (the situation in the illustrated embodiment) or stretched (not shown) to generate an elastic force. Therefore, it is necessary for the second magnetic conductive member 40 to overcome the elastic force of the elastic element 60 to move toward the first magnetic conductive member 30. Specifically, the attraction between the first magnetic conductive member 30 and the second magnetic conductive member 40 overcomes the elastic force of the elastic element 60 to cause the second magnetic conductive member 40 to move toward the first magnetic conductive member 30.

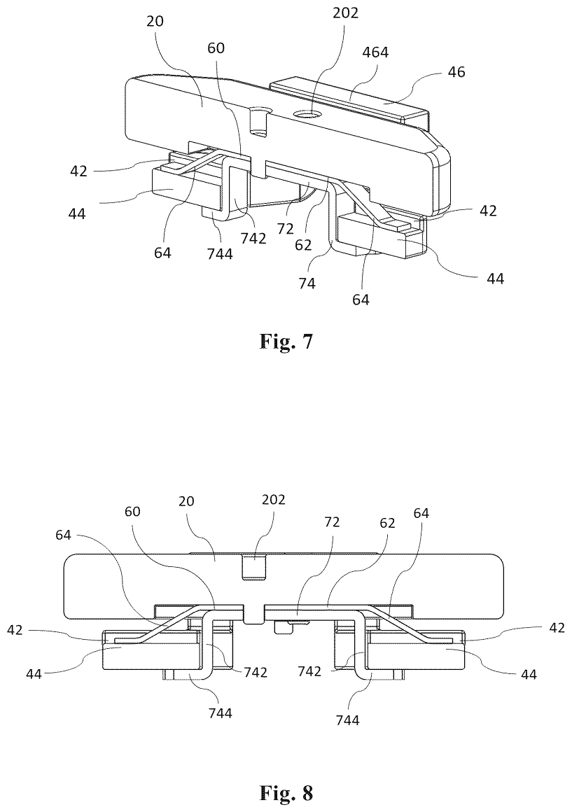

As shown in FIGS. 6 to 7, the elastic element 60 is in the form of a butterfly spring. One butterfly spring is shown in the illustrated embodiment, but those skilled in the art should understand that any suitable number of butterfly springs may be adopted according to actual application needs. The elastic element 60 is disposed between the movable contact element 20 and the second magnetic conductive member 40. In the case where the second magnetic conductive member 40 continues to move toward the first magnetic conductive member 30 when the movable contact element 20 contacts the stationary contact element 10, since the movable contact element 20 remains immobile at this time, the second magnetic conductive member 40 also moves relative to the movable contact element 20, specifically moving toward (the situation in the illustrated embodiment) the movable contact element 20. The elastic element 60 between the movable contact element 20 and the second magnetic conductive member 40 generates an elastic force due to elastic deformation. Therefore, it is necessary for the second magnetic conductive member 40 to overcome the elastic force of the elastic element 60 to move toward the first magnetic conductive member 30. Specifically, the attraction between the first magnetic conductive member 30 and the second magnetic conductive member 40 overcomes the elastic force of the elastic element 60 to cause the second magnetic conductive member 40 to move toward the first magnetic conductive member 30. In the magnetic circuit constituted by the first magnetic conductive member 30 and the second magnetic conductive member 40, current generates a magnetic field, and the magnetic field in turn generates an attraction. Therefore, the current is related to the attraction. In this case, the elastic element 60 can be designed to be related to the current in the magnetic circuit. For example, in the case where the current in the magnetic conductive circuit reaches a current threshold value, the attraction generated between the first magnetic conductive member 30 and the second magnetic conductive member 40 overcomes the elastic force of the elastic element 60, such that the second magnetic conductive member 40 begins to move toward the first magnetic conductive member 30.

As described above, when the second magnetic conductive member 40 continues to move toward the first magnetic conductive member 30 while the movable contact element 20 contacts the stationary contact element 10, the elastic element 60 between the movable contact element 20 and the second magnetic conductive member 40 generates an elastic force, which in turn helps bias the movable contact element 20 to maintain contact with the stationary contact element 10.

By providing the elastic element 60 between the movable contact element 20 and the second magnetic conductive member 40, it can not only help regulate the distance and attraction between the first magnetic conductive member 30 and the second magnetic conductive member 40, but also help bias the movable contact element 20 to maintain contact with the stationary contact element 10.

According to some embodiments of the present application, the second magnetic conductive member 40 can be coupled to the movable contact element 20 via the elastic element 60.

The elastic element 60 can be coupled to the second magnetic conductive member 40 in various suitable manners such as threaded connection and welding, and connected to the movable contact element 20, thereby coupling the second magnetic conductive member 40 to the movable contact element 20, thus facilitating movement of the second magnetic conductive member 40 following the movable contact element 20.

According to some embodiments of the present application, the movable contact element 20 can be located between the first magnetic conductive member 30 and the second magnetic conductive member 40.

In the illustrated embodiment, the movable contact element 20 is interposed between the first magnetic conductive member 30 and the second magnetic conductive member 40, i.e., the first magnetic conductive member 30 and the second magnetic conductive member 40 are respectively located on opposite sides of the movable contact element 20. In this way, when the second magnetic conductive member 40 moves toward the first magnetic conductive member 30 while the movable contact element 20 contacts the stationary contact element 10, the second magnetic conductive member 40 also moves toward the movable contact element 20. The elastic element 60 between the movable contact element 20 and the second magnetic conductive member 40 is compressed or undergoes elastic deformation to generate an elastic force, which in turn biases the movable contact element 20 toward the stationary contact element 10.

A person skilled in the art can understand that, in unillustrated embodiments, the second magnetic conductive member 40 can also be located between the movable contact element 20 and the first magnetic conductive member 30, i.e., the movable contact element 20 and the first magnetic conductive member 30 are respectively located on opposite sides of the second magnetic conductive member 40. In this way, when the second magnetic conductive member 40 moves toward the first magnetic conductive member 30 while the movable contact element 20 contacts the stationary contact element 10, the second magnetic conductive member 40 moves away from the movable contact element 20. The elastic element 60 between the movable contact element 20 and the second magnetic conductive member 40 is stretched or undergoes elastic deformation to generate an elastic force, which in turn pulls the movable contact element 20 toward the stationary contact element 10 to help maintain contact between the movable contact element 20 and the stationary contact element 10.

In the case where the movable contact element 20 is located between the first magnetic conductive member 30 and the second magnetic conductive member 40, the overall layout structure of the magnetic conductive members and the contact elements is more compact, and can better control and regulate the distance between the first magnetic conductive member 30 and the second magnetic conductive member 40, avoiding occurrence of unexpected situations.

According to some embodiments of the present application, the second magnetic conductive member 40 can be configured to move relative to the movable contact element 20 between a first position and a second position, wherein the distance between the first magnetic conductive member 30 and the second magnetic conductive member 40 when in the first position is greater than the distance between the first magnetic conductive member 30 and the second magnetic conductive member 40 when in the second position. The elastic element 60 is configured to bias the second magnetic conductive member 40 toward the first position.

Before the movable contact element 20 contacts the stationary contact element 10, the second magnetic conductive member 40 does not move relative to the movable contact element 20, and is located in the first position. In the illustrated embodiment, in the case where the movable contact element 20 is located between the first magnetic conductive member 30 and the second magnetic conductive member 40, in the first position, the distance between the second magnetic conductive member 40 and the movable contact element 20 is at a maximum distance. In the case where the second magnetic conductive member 40 can also be located between the movable contact element 20 and the first magnetic conductive member 30, in the first position, the distance between the second magnetic conductive member 40 and the movable contact element 20 is at a minimum distance. When the movable contact element 20 contacts the stationary contact element 10, the second magnetic conductive member 40 continues to move toward the first magnetic conductive member 30 while overcoming the elastic force of the elastic element 60. In the case of the illustrated embodiment, at this time the second magnetic conductive member 40 also moves toward the movable contact element 20, thereby reducing the distance between the second magnetic conductive member 40 and the movable contact element 20 and reducing the distance between the first magnetic conductive member 30 and the second magnetic conductive member 40. In the case where the second magnetic conductive member 40 can also be located between the movable contact element 20 and the first magnetic conductive member 30, the second magnetic conductive member 40 moves away from the movable contact element 20, thereby increasing the distance between the second magnetic conductive member 40 and the movable contact element 20 and reducing the distance between the first magnetic conductive member 30 and the second magnetic conductive member 40. When the attraction between the first magnetic conductive member 30 and the second magnetic conductive member 40 finally balances with the elastic force of the elastic element 60, or when the movement of the second magnetic conductive member 40 toward the first magnetic conductive member 30 is obstructed (e.g., blocked by the movable contact element 20), the distance between the first magnetic conductive member 30 and the second magnetic conductive member 40 reaches the minimum distance, and the second magnetic conductive member 40 is in the second position.

In the first position, elastic deformation of the elastic element 60 is minimum and elastic force generated thereby is minimum. In the second position, elastic deformation of the elastic element 60 is maximum and elastic force generated thereby is maximum. The elastic element 60 biases the second magnetic conductive member 40 toward the first position.

The biasing of the elastic element 60 can facilitate adjustment of distance between the first magnetic conductive member 30 and the second magnetic conductive member 40, and facilitate resetting of the second magnetic conductive member 40.

According to some embodiments of the present application, the second magnetic conductive member 40 may be provided with a first receiving portion 42, and the movable contact element 20 may be provided with a corresponding second receiving portion 22. Two ends of the elastic element 60 may be received respectively at the first receiving portion 42 and the second receiving portion 22.

As shown in FIGS. 3-5, they show that the elastic element 60 is in the form of a helical spring. The second magnetic conductive member 40 may be formed with an abutment section 44, and the elastic element 60 may abut against the abutment section 44. A first receiving portion 42 for receiving the elastic element 60 may be formed on the abutment section 44. The first receiving portion 42 may be in the form of, for example, a recess or groove. An end of the elastic element 60 in the form of a helical spring may be received in the recess or groove.

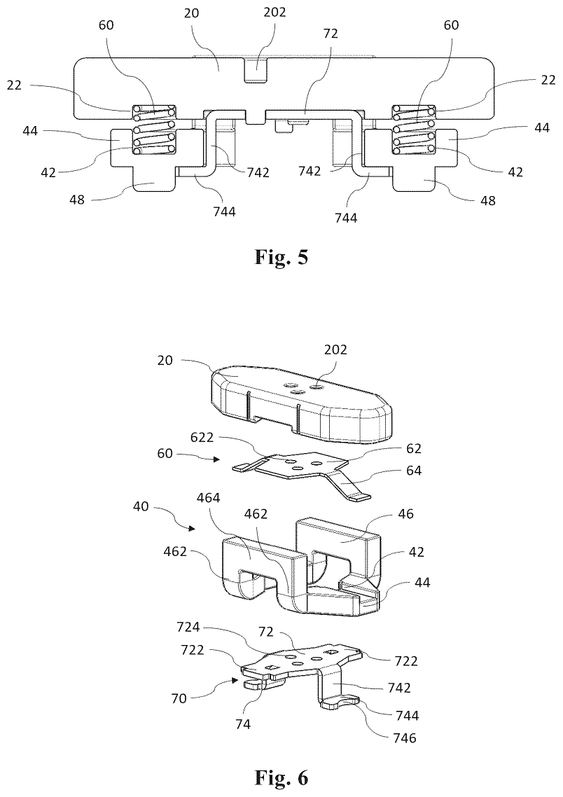

As shown in FIGS. 4 and 5, a second receiving portion 22 may be formed at a position on the movable contact element 20 corresponding to the first receiving portion 42. The second receiving portion 22 may also be in the form of, for example, a recess or groove. Another end of the elastic element 60 in the form of a helical spring may be received in the recess or groove.

The above description about the first receiving portion 42 and the second receiving portion 22 is merely exemplary. It will be understood by those skilled in the art that the receiving portions may adopt any other suitable form in addition to a recess or groove. For example, in an embodiment not shown, the first receiving portion 42 may be in the form of a pin or protrusion, and the helical spring is arranged around the pin or protrusion. At this time, the second receiving portion 22 may be in the form of, for example, a recess or groove. Similarly, the second receiving portion 22 may be in the form of a pin or protrusion, and the helical spring is arranged around the pin or protrusion. At this time, the first receiving portion 42 may be in the form of, for example, a recess or groove. Or, both the first receiving portion 42 and the second receiving portion 22 are in the form of a pin or protrusion, and the helical spring is arranged around the pin or protrusion.

In the illustrated embodiment, the second magnetic conductive member 40 is formed with two abutment sections 44. Accordingly two first receiving portions 42 are formed, while two second receiving portions 22 are correspondingly formed on the movable contact element 20. However, it will be appreciated by those skilled in the art that the number of the receiving portions matches the number of the elastic elements 60, and may be selected according to needs and design of actual application, so as to facilitate provision of desired elastic force.

Dimensions of the first receiving portion 42 and the second receiving portion 22, such as the depth and diameter thereof, may be determined based on parameters (such as length and outer diameter) of the elastic element 60, so as to ensure that an elastic element 60 (helical spring) having suitable dimensions (such as length and outer diameter) can be adopted to obtain desired compression dimension and elastic force, so as to facilitate adjustment of distance between the second magnetic conductive member 40 and the movable contact element 20. On the other hand, the elastic element 60 is received in the first receiving portion 42 and the second receiving portion 22, which can also prevent the elastic element 60 from shifting in the length direction (X direction) and width direction (Y direction), and be helpful for normal operation of the elastic element 60, i.e., compression and elongation of the helical spring in the height direction (Z direction).

The provision of the receiving portions can facilitate adjustment of distance between the second magnetic conductive member 40 and the movable contact element 20, and can also constrain shift movement of the elastic element 60, which is helpful for normal operation of the elastic element 60.

According to some embodiments of the present application, the second magnetic conductive member 40 may be provided with a first receiving portion 42, and the elastic element 60 may include a spring body 62 and a deformable portion 64 extending from the spring body 62. The spring body 62 may be fixed to the movable contact element 20, and an end of the deformable portion 64 may be received at the first receiving portion 42.

As shown in FIGS. 6-8, they show that the elastic element 60 is in the form of a butterfly spring. The second magnetic conductive member 40 may be formed with an abutment section 44, and the elastic element 60 may abut against the abutment section 44. A first receiving portion 42 for receiving the elastic element 60 may be formed on the abutment section 44. The first receiving portion 42 may be in the form of, for example, a slide slot. Likewise, it will be understood by those skilled in the art that the first receiving portion 42 may be in any other suitable form in addition to a slide slot. For example, in an embodiment not shown, the first receiving portion 42 may be in the form of a slide rail or other guiding sliding structure.

The elastic element 60 includes a spring body 62 and a deformable portion 64 extending from the spring body 62. In the illustrated embodiment, two deformable portions 64 are shown, each extending outwardly from a respective side of the spring body 62. Those skilled in the art should understand that the number and shape of the deformable portion 64 may be selected and designed according to needs of actual application. In the case of having two deformable portions 64, the second magnetic conductive member 40 may be correspondingly provided with two first receiving portions 42, and an end of each deformable portion 64 is received in a corresponding first receiving portion 42.

Dimension and shape of the first receiving portion 42 may be determined based on dimension and shape of the deformable portion 64. The spring body 62 of the elastic element 60 may be fixed to the movable contact element 20 via various suitable manners such as threaded connection, riveting, pin connection, welding, etc. For example, in the illustrated embodiment, three mounting holes 202 are formed on the movable contact element 20, and correspondingly, three mounting holes 622 are formed on the spring body 62. Therefore, the spring body 62 may be fixed to the movable contact element 20 via bolts, rivets, pins, etc. passing through these mounting holes 202, 622. The elastic element 60 is disposed between the movable contact element 20 and the second magnetic conductive member 40. When the second magnetic conductive member 40 moves toward the movable contact element 20, the deformable portion 64 of the elastic element 60 correspondingly undergoes elastic deformation to generate elastic force, so as to bias the second magnetic conductive member 40, e.g., bias the second magnetic conductive member 40 toward its first position. During the process where the deformable portion 64 undergoes elastic deformation, an end of the deformable portion 64 may slide in the first receiving portion 42, e.g., slide in the length direction in the illustrated embodiment. Thus, the first receiving portion 42 may serve as a guiding function, and may also prevent the deformable portion 64 from shifting.

Similarly, the spring body 62 is fixed to the movable contact element 20 and the first receiving portion 42 guides and constrains movement of the deformable portion 64, which can facilitate adjustment of a distance between the second magnetic conductive member 40 and the movable contact element 20 and is helpful for normal operation of the elastic member 60.

According to some embodiments of the present application, the second magnetic conductive member 40 may be formed as a U-shaped structure, and the movable contact element 20 may be disposed between two sides of the U-shaped structure, such that when the second magnetic conductive member 40 moves toward the first magnetic conductive member 30, the second magnetic conductive member 40 can be guided along an edge of the movable contact element 20 to move relative to the movable contact element 20.

As shown in FIGS. 3 and 6, the second magnetic conductive member 40 may include an abutment section 44 and protruding sections 46 extending in the height direction from opposite sides of the abutment section 44 in the width direction. Therefore, the abutment section 44 and the protruding sections 46 are integrally formed into a U-shaped structure. The movable contact element 20 may be disposed between two sides of the U-shaped structure, i.e., disposed between two protruding sections 46 opposite to each other in the width direction, facing the abutment section 44 in the height direction. When the stationary contact element 10 contacts the movable contact element 20, the second magnetic conductive member 40 will continue to move toward the first magnetic conductive member 30. At this time the second magnetic conductive member 40 will move in the height direction relative to the movable contact element 20. Since the movable contact element 20 is located between the two protruding sections 46, the second magnetic conductive member 40 can be guided along two edges of the movable contact element 20 opposite to each other in the width direction to move in the height direction. Meanwhile the movable contact element 20 can prevent shifting of the second magnetic conductive member 40 in the width direction.

By forming the second magnetic conductive member 40 into a U-shaped structure and disposing the movable contact element 20 between two sides of the U-shaped structure, movement of the second magnetic conductive member 40 in the height direction can be guided and shifting of the second magnetic conductive member 40 in the width direction can be prevented.

According to some embodiments of the present application, the relay 1 may further include a mounting bracket 70, which may be fixed to the movable contact element 20 to movably constrain the second magnetic conductive member 40 between the mounting bracket 70 and the movable contact element 20.

As shown in FIGS. 3-8, the mounting bracket 70 is used for movably mounting the second magnetic conductive member 40 to the movable contact element 20. In some embodiments, the mounting bracket 70 may be fixed to the movable contact element 20, such that the mounting bracket 70 will not move relative to the movable contact element 20. The second magnetic conductive member 40 is disposed between the mounting bracket 70 and the movable contact element 20, and can move in the height direction relative to the mounting bracket 70 and the movable contact element 20, but can only move between the mounting bracket 70 and the movable contact element 20 due to being constrained by the mounting bracket 70 and the movable contact element 20, and cannot move out of the mounting bracket 70 and the movable contact element 20.

On one hand, the mounting bracket 70 can movably connect the second magnetic conductive member 40 to the movable contact element 20, and on the other hand, it can constrain movement of the second magnetic conductive member 40, which facilitates defining a range of movement of the second magnetic conductive member 40.

According to some embodiments of the present application, the mounting bracket 70 may have a bracket body 72, which may be fixed to the movable contact element 20.

The bracket body 72 may be fixed to the movable contact element 20 via various suitable manners such as threaded connection, riveting, pin connection, welding, etc. For example, in the illustrated embodiment, three mounting holes 202 are formed on the movable contact element 20, and correspondingly, three mounting holes 724 are formed on the bracket body 72. Therefore, the bracket body 72 can be fixed to the movable contact element 20 via bolts, rivets, pins, etc. passing through these mounting holes 202, 724.

In a case where the elastic member 60 is a butterfly spring, as shown in FIGS. 6-8, three mounting holes 622 are formed on the spring body 62 of the elastic member 60. Therefore, the spring body 62 can be fixed to the movable contact element 20 via bolts, rivets, pins, etc. passing through the mounting holes 202, 622. At this time, both the spring body 62 and the bracket body 72 are fixed to the movable contact element 20. For this purpose, the spring body 62 and the bracket body 72 can be fixed to the movable contact element 20 via bolts, rivets, pins, etc. passing through the mounting holes 202, 622, 724. In the illustrated embodiment, the spring body 62 is located between the movable contact element 20 and the bracket body 72. In an unillustrated embodiment, the bracket body 72 may be located between the movable contact element 20 and the spring body 62. Alternatively, any other suitable fixing arrangement may also be adopted. For example, the spring body 62 and the bracket body 72 are fixed to the movable contact element 20 side-by-side or integrally (i.e., the mounting bracket 70 and the elastic member 60 may be integrally formed).

According to some embodiments of the present application, each of two ends of the bracket body 72 may be formed with a supporting section 722 configured for supporting the second magnetic conductive member 40.

As shown in the figures, supporting sections 722 are respectively formed at two ends of the bracket body 72. In a case where the second magnetic conductive member 40 is disposed between the mounting bracket 70 and the movable contact element 20, the supporting sections 722 can be used for supporting the second magnetic conductive member 40.

According to some embodiments of the present application, the second magnetic conductive member 40 may include two protruding sections 46. Each protruding section 46 may be formed in a form of a U-shaped structure. The movable contact element 20 may be disposed between the two protruding sections 46. Each of the supporting sections 722 may be respectively disposed between two legs 462 of a corresponding protruding section 46 and configured for supporting a connecting portion 464 of the corresponding protruding section 46.

According to some embodiments of the present application, the second magnetic conductive member 40 may include two abutment sections 44. Each abutment section 44 may be connected to one corresponding leg of each of the two protruding sections 46, such that the two abutment sections 44 and the two protruding sections 46 jointly form a U-shaped structure.

As shown in the figures, the second magnetic conductive member 40 may include two protruding sections 46 and two abutment sections 44, which are connected to each other to form an integral U-shaped structure. Specifically, the two abutment sections 44 may be arranged separately in the length direction. The two protruding sections 46 are disposed between the two abutment sections 44 in the length direction and extend from the abutment sections 44 in the height direction. These two protruding sections 46 are provided opposite to each other in the width direction. Each protruding section 46 may be formed into the form of a U-shaped structure, which includes two legs 462 extending in the height direction and a connecting portion 464 extending in the length direction and connected between the two legs 462. One leg 462 of one protruding section 46 and one leg 462 of another protruding section 46 are connected to one abutment section 44, and another leg 462 of the one protruding section 46 and another leg 462 of the another protruding section 46 are connected to another abutment section 44. Therefore, the two abutment sections 44 and the two protruding sections 46 are commonly formed into a U-shaped structure. Thus, a space for accommodating the mounting bracket 70 is formed between the two abutment sections 44 and between the legs 462 of the two protruding sections 46. After the movable contact element 20, the second magnetic conductive member 40 and the mounting bracket 70 are assembled, a very compact structure can be formed.

The movable contact element 20 may be disposed between the two protruding sections 46 so as to guide the movement of the second magnetic conductive member 40 in the height direction and prevent the shifting of the second magnetic conductive member 40 in the width direction. The supporting sections 722 may be located at both ends of the bracket body 72 in the width direction, such that the supporting sections 722 can be respectively disposed between the two legs 462 of the corresponding protruding section 46, i.e., one supporting section 722 is disposed between the two legs 462 of one protruding section 46, and another supporting section 722 is disposed between the two legs 462 of another protruding section 46. Thus, the two supporting sections 722 can be used to support the connecting portions 464 of the two protruding sections 46 respectively. Therefore, the mounting bracket 70 plays a role in supporting the second magnetic conductive member 40 and preventing the second magnetic conductive member 40 from falling out between the movable contact element 20 and the mounting bracket 70. Meanwhile, the supporting sections 722 are located between the legs 462 of the protruding sections 46, which can also prevent the shifting of the second magnetic conductive member 40 in the length direction and guide the movement of the second magnetic conductive member 40 in the height direction.

This arrangement of the second magnetic conductive member 40 and the mounting bracket 70 not only can obtain a compact arrangement and support and constrain the second magnetic conductive member 40, but also can guide the movement of the second magnetic conductive member 40 in the height direction and prevent the shifting of the second magnetic conductive member 40 in the length direction.

According to some embodiments of the present application, the mounting bracket 70 may have a bracket section 74 extending from the bracket body 72, the second magnetic conductive member 40 may include an abutment section 44, and the bracket section 74 may be configured to support the abutment section 44 and/or guide the movement of the abutment section 44.

According to some embodiments of the present application, the second magnetic conductive member 40 may include two abutment sections 44, and the mounting bracket 70 correspondingly may have two bracket sections 74 extending from opposite sides of the bracket body 72.

As shown in the figures, the mounting bracket 70 may include two bracket sections 74 extending substantially in the height direction from the two sides of the bracket body 72 facing each other in the length direction. The number, size and shape of the bracket sections 74 extending from the bracket body 72 may be selected according to actual application needs, for example, to match the size and shape of the abutment section 44. The bracket section 74 extends through the space between the two abutment sections 44 and between the legs 462 of the two protruding sections 46 to the lower side of the abutment section 44, thereby supporting the abutment section 44 in the height direction and preventing the second magnetic conductive member 40 from falling out between the movable contact element 20 and the mounting bracket 70.

In the case where the bracket section 74 extends substantially in the height direction, the bracket section 74 can also play a guiding role. When the second magnetic conductive member 40 moves in the height direction relative to the movable contact element 20, the abutment section 44 can move along the bracket section 74 to be guided to move in the height direction. Meanwhile the bracket section 74 can also prevent the abutment section 44 from shifting in the length direction.

According to some embodiments of the present application, the bracket section 74 may include a guiding portion 742 extending from the bracket body 72 and a supporting portion 744 extending from an end of the guiding portion 742 opposite to the bracket body 72, the guiding portion 742 cooperates with the abutment section 44 to guide the movement of the abutment section 44, and the supporting portion 744 is configured to support the abutment section 44.

As shown in the drawings, the guiding portion 742 may extend from the bracket body 72 in the height direction. Therefore, when the second magnetic conductive member 40 moves relative to the movable contact element 20, the abutment section 44 of the second magnetic conductive member 40 can move along the guiding portion 742 to be guided to move in the height direction, which can also prevent the abutment section 44 from shifting in the length direction. The supporting portion 744 may extend to the lower side of the abutment section 44, thereby supporting the abutment section 44 in the height direction and preventing the second magnetic conductive member 40 from falling out between the movable contact element 20 and the mounting bracket 70.

According to some embodiments of the present application, a protrusion 48 may be provided on the abutment section 44, and the supporting portion 744 may be formed with a guiding recess 746 cooperating with the protrusion 48 to guide the movement of the protrusion 48.

As shown in FIGS. 3-5, a protrusion 48 may be formed below the abutment section 44. The protrusion 48 may be in the form of a cylindrical protrusion extending from the abutment section 44 in the height direction. An end of the supporting portion 744 opposite to the guiding portion 742 may be formed with a guiding recess 746, the contour of which may match the shape of the protrusion 48, so as to cooperate with the protrusion 48 to guide the movement of the protrusion 48 in the height direction when the second magnetic conductive member 40 moves relative to the movable contact element 20.

The relay according to the present application regulates a distance between the magnetic conductive members by adopting a floating magnetic conductive structure, so as to regulate attraction between the magnetic conductive members. Further, by providing the magnetic conductive member associated with the movable contact element into a floating magnetic conductive member, not only can the distance be regulated, but also elastic force of the elastic element can be fully utilized to additionally promote contact between the stationary contact element and the movable contact element. In addition, assembly of the movable contact element, the mounting bracket and the magnetic conductive member forms a compact structure, which fully utilizes shape cooperation between the respective members, not only saves space, but also obtains additional guiding and constraining effects.

Although exemplary embodiments of the present application have been described, those skilled in the art should understand that various modifications and changes can be made to the exemplary embodiments of the present application without departing from the spirit and scope of the present application. Therefore, all modifications and changes are included within the protection scope of the present application defined by the claims. The present application is defined by the appended claims, and equivalents of these claims are also included.

1. A relay comprising:
a stationary contact element extending into a contact chamber defined by a housing of the relay;
a movable contact element configured to move toward the stationary contact element during operation such that the movable contact element comes into contact with the stationary contact element to achieve conduction of an electric circuit;
a first magnetic conductive member disposed within the contact chamber; and
a second magnetic conductive member coupled to the movable contact element and configured to form a magnetic circuit with the first magnetic conductive member when the movable contact element contacts the stationary contact element;
wherein the second magnetic conductive member is configured to be movable toward the first magnetic conductive member when the movable contact element contacts the stationary contact element, so as to change a distance between the first magnetic conductive member and the second magnetic conductive member.

2. The relay according to claim 1, wherein an elastic element is provided between the movable contact element and the second magnetic conductive member, such that the second magnetic conductive member moves toward the first magnetic conductive member against an elastic force of the elastic element when the movable contact element contacts the stationary contact element.

3. The relay according to claim 2, wherein the second magnetic conductive member is coupled to the movable contact element via the elastic element.

4. The relay according to claim 2, wherein the movable contact element is located between the first magnetic conductive member and the second magnetic conductive member.

5. The relay according to claim 2, wherein the second magnetic conductive member is configured to move between a first position and a second position relative to the movable contact element, wherein a distance between the first magnetic conductive member and the second magnetic conductive member when in the first position is greater than a distance between the first magnetic conductive member and the second magnetic conductive member when in the second position, and wherein the elastic element is configured to bias the second magnetic conductive member toward the first position.

6. The relay according to claim 2, wherein the elastic element is a helical spring or a butterfly spring.

7. The relay according to claim 2, wherein the second magnetic conductive member is provided with a first receiving portion, the movable contact element is provided with a corresponding second receiving portion, and two ends of the elastic element are received at the first receiving portion and the second receiving portion, respectively.

8. The relay according to claim 2, wherein the second magnetic conductive member is provided with a first receiving portion, and the elastic element includes a spring body and a deformable portion extending from the spring body, and wherein the spring body is fixed to the movable contact element, and an end of the deformable portion is received at the first receiving portion.

9. The relay according to claim 1, wherein the second magnetic conductive member is formed as a U-shaped structure, the movable contact element is arranged between two sides of the U-shaped structure, such that when the second magnetic conductive member moves toward the first magnetic conductive member, the second magnetic conductive member is guided along an edge of the movable contact element to move relative to the movable contact element.

10. The relay according to claim 1, wherein the relay further includes a mounting bracket fixed to the movable contact element to movably constrain the second magnetic conductive member between the mounting bracket and the movable contact element.

11. The relay according to claim 10, wherein the mounting bracket has a bracket body fixed to the movable contact element.

12. The relay according to claim 11, wherein each of two ends of the bracket body is formed with a supporting section configured for supporting the second magnetic conductive member.

13. The relay according to claim 12, wherein the second magnetic conductive member includes two protruding sections each formed in the form of a U-shaped structure, the movable contact element is arranged between the two protruding sections, and each of the supporting sections is arranged between two legs of a respective protruding section and configured for supporting a connecting portion of the respective protruding section.

14. The relay according to claim 13, wherein the second magnetic conductive member includes two abutment sections each connected to one corresponding leg of each of the two protruding sections, such that the two abutment sections and the two protruding sections together form a U-shaped structure.

15. The relay according to claim 11, wherein the mounting bracket has a bracket section extending from the bracket body, and the second magnetic conductive member includes an abutment section, and wherein the bracket section is configured for supporting the abutment section and/or guiding movement of the abutment section.

16. The relay according to claim 15, wherein the second magnetic conductive member includes two abutment sections, and the mounting bracket correspondingly has two bracket sections extending from opposite sides of the bracket body.

17. The relay according to claim 15, wherein the bracket section includes a guiding portion extending from the bracket body and a supporting portion extending from an end of the guiding portion opposite to the bracket body, the guiding portion cooperates with the abutment section to guide movement of the abutment section, and the supporting portion is configured for supporting the abutment section.

18. The relay according to claim 17, wherein the abutment section is provided with a protrusion, and the supporting portion is formed with a guiding recess cooperating with the protrusion to guide movement of the protrusion.
